(19) United States
(12) Patent Application Publication
(10) Pub. No.: US 2026/0285147 A1
(43) Pub. Date: Sep. 24, 2026

(54) ELECTRIC DRIVE DEVICE FOR A MOTOR VEHICLE

(71) Applicant: MERCEDES-BENZ GROUP AG, Stuttgart (DE)

(72) Inventors: Tobias SCHILDER, Ludwigsburg (DE); Tobias HAERTER, Stuttgart (DE); Cornelius HENTRICH, Waiblingen (DE); Philip KONOWALCZYK, Tübingen (DE)

(21) Appl. No.: 19/122,322

(22) PCT Filed: Sep. 29, 2023
(86) PCT No.: PCT/EP2023/077161

§ 371 Date: Apr. 18, 2025

(30) Foreign Application Priority Data
Oct. 20, 2022 (DE) 10 2022 003 889.7

(51) Int. Cl. B60K 17/04; B60K 7/00; B60K 17/02; F16H 3/60

(52) U.S. Cl. CPC B60K 17/046; B60K 7/0007; B60K 17/02; F16H 3/60; B60K 2007/0092

(57) ABSTRACT

An electric drive device for a motor vehicle includes an electric engine having a rotor; a planetary gear stage, which has a sun gear, a planetary carrier with planetary gears and a ring gear, as well as a switchable freewheel clutch having a first coupling half, a second coupling half, a switching element, and an actuator. The first coupling half is connected to a housing for conjoint rotation. An axial guide ring is provided to support the ring gear in both axial directions. The ring gear is designed to be free from a roller bearing which directly supports it.

### BACKGROUND AND SUMMARY OF THE INVENTION

Exemplary embodiments of the invention relate to an electric drive device for a motor vehicle.

DE 10 2019 114 139 B3 describes a prior art in the form of a motor vehicle transmission for coupling an electric engine to a drive train. In this case, a planetary gear stage having a sun gear, a planetary carrier with planetary gears and a ring gear is provided between the electric engine and the drive train. A switchable freewheel is also arranged in the vehicle transmission, which is able to switchably couple the sun gear to a reference component, in particular a stationary housing, via two coupling halves, in a way that optionally brings about freewheeling and/or blocking of the sun gear with respect to the housing. The features mentioned herein in relation to DE 10 2019 114 139 B3 are also disclosed by the generic document US 2012/0149520 A1, which additionally discloses an axial guide for the ring gear. A ring-shaped axial guide in its own right is known from U.S. Pat. No. 4,428,689 A1.

An electric drive device having a rotor, which is arranged coaxially to a planetary gear stage, and having a disc unit, which is arranged axially on a side of the planetary gear stage facing away from the rotor, is known from DE 10 2015 110 565 A1.

Exemplary embodiments of the present invention are directed to an electric drive device for a motor vehicle, which is further improved over the mentioned construction of the prior art by simplifying the construction so that installation space, components and costs can be saved. Performance and durability of the electric drive device is not to be impaired in the process.

The starting point is an electric drive device for a motor vehicle having an electric engine, wherein the electric engine in turn has a rotor. The electric drive device also has a planetary gear stage having a sun gear, having a planetary carrier with associated planetary gears and having a ring gear. The electric drive device also comprises a switchable freewheel clutch which has a first coupling half, a second coupling half, a switching element, and an actuator, wherein the first coupling half is connected to a housing for conjoint rotation.

The design, according to the invention, of the electric drive device for a motor vehicle provides that the ring gear is designed without a separate roller bearing directly supporting the ring gear and is only supported via an axial guide ring in both axial directions. The inventors take advantage of the fact here that the third shaft does not have to be mounted radially when two shafts of a planetary transmission are mounted radially. Therefore, the term “radial” always refers to a central rotational axis of the sun gear, or the planetary carrier, or the ring gear, of the planetary transmission (here the planetary gear stage). A roller bearing for the ring gear, which represents the component with the relatively largest diameter of the planetary gear stage, can therefore be omitted. This means that costs, installation space and weight of a relatively large roller bearing are saved. The axial guide ring for the axial support of the ring gear brings advantages with regard to function and durability of the planetary gear stage.

The feature that the ring gear is designed without a separate roller bearing directly supporting the ring gear, means that the ring gear is mounted at most indirectly by roller bearings. Indirect mounting of the ring gear is therefore possible by means of a roller bearing. Indirect mounting means that it is not the ring gear that is directly mounted on roller bearings, but a gear element, which is arranged between the ring gear and a corresponding roller bearing, can be directly mounted on roller bearings. The gear element mentioned here, which is arranged between the ring gear and the roller bearing, means a gear element that is not connected to the ring gear for conjoint rotation, meaning that differential speeds can occur between the mentioned gear element and the ring gear. The ring gear can be mounted, for example, indirectly with respect to the housing by the planetary carrier being mounted directly with respect to the housing, but the ring gear supports itself with respect to the planetary carrier (via intermediary planetary gears) without an intermediary roller bearing.

The ring gear itself is centered by the shafts of the two other elements of the planetary gear stage, i.e., the planetary carrier and the sun gear. The axial guide ring of the invention then only serves to ensure that the ring gear does not move significantly axially. As no significant axial forces act on the ring gear itself in the present embodiment of the planetary gear stage because it is centered via the other elements when in the non-connected state and is fixed with respect to the housing in the connected state, very simple axial guidance via the axial guide ring is sufficient, which does not have to meet any high requirements with regard to mechanical stability or frictional properties.

With regard to an indirect roller bearing of the ring gear, for example, the rotor shaft of the electric engine is mounted by rolling bearings directly with respect to the housing and supports the sun gear, i.e., this is also mounted accordingly. The further element would then be the planetary carrier, which as described above is similarly directly mounted with respect to the housing by roller bearings. This construction could clearly be reversed so that the sun gear would independently be directly mounted with respect to the housing by roller bearings and the planetary carrier would be mounted indirectly with respect to the housing via the rotor shaft by roller bearings. In both cases, the ring gear is now supported indirectly on the housing by the interaction with the planetary gears located on the planetary gear carrier and, on the one hand, the sun via this bearing of the sun gear and, on the other hand, the planetary gear carrier, and thus itself does not necessarily require a separate direct roller bearing with respect to the housing, assuming the axial guide ring according to the invention is present.

Torque transmission between the rotor and a driven gear of the electric drive device can be interrupted via the switchable freewheel clutch, such that the driven gear can in fact rotate almost loss-free with respect to the rotor and drag losses can be avoided, e.g., in a situation in which the vehicle is actively driven exclusively by at least one other axle.

It is also provided according to the invention that the axial guide ring is arranged radially inside and axially overlapping the freewheel clutch.

“Radially inside” refers again to the central rotational axis of the planetary gear stage and means that the axial guide ring is located in a region with smaller radii than the switchable freewheel clutch. “Axially overlapping”, similarly relating to the same axis, means that the two components concerned, which are arranged axially overlapping, are arranged at least partially in a region of the same axial coordinates in the axial direction of the rotational axis of the planetary gear stage.

According to an extraordinarily favorable development of the electric drive device according to the invention, it can also be provided that the axial guide ring has a u-shaped cross-section contour. The axial guide ring can, for example, axially guide the ring gear itself or a disc connected to the ring gear, for example in the form of or as a section of a disc unit, and thus prevent the ring gear from moving axially.

Advantageously, the axial guide ring is connected axially fixed to the housing for conjoint rotation, such that advantageously the ring gear is axially secured directly with respect to the housing by means of the axial guide ring.

In the entirety of the present disclosure, the terms “for conjoint rotation” and “axially fixed” mean the following: Two rotatably mounted elements are connected to each other for conjoint rotation when they are arranged coaxially to each other and are connected to each other in such a way that they rotate at the same angular velocity. An element is connected to the housing for conjoint rotation when it cannot be rotated relative to the housing. An element is connected axially fixed to another element when the one element cannot be moved axially relative the other element with regard to the rotational axis of the planetary gear stage.

A further very advantageous embodiment of the electric drive device according to the invention can also provide that the second coupling half of the switchable freewheel clutch is connected to the ring gear for conjoint rotation, wherein a connecting element, which is connected to the ring gear for conjoint rotation and to the second coupling half for conjoint rotation, is arranged radially between a sun gear toothing of the sun gear and a ring gear toothing of the ring gear in relation to a rotational axis of the planetary gear stage. The switchable freewheel clutch between the ring gear and housing is arranged very favorably in this design and enables a simple-to-mount and very compact construction of the electric drive device.

The arrangement of the connecting element in its radial position between the sun gear toothing and the ring gear toothing and thus the connection of the ring gear to the second coupling half radially inwards ensures a very compact construction of the electric drive device in the radial direction.

According to a very advantageous development of the electric drive device according to the invention, the connecting element can have a cylinder section arranged coaxially to the rotational axis of the planetary gear stage.

Advantageously, the connecting element also has a disc unit connected to the cylinder section for conjoint rotation, wherein the disc unit is also connected to the ring gear for conjoint rotation. Advantageously, the ring gear, the disc unit, and the cylinder section are arranged successively in the mentioned order with regard to a torque flow, which emanates from the ring gear and runs to the second coupling half.

Preferably, the rotor of the electric engine can be arranged coaxially to the planetary gear stage and the disc unit can be arranged axially on a side of the planetary gear stage facing away from the rotor. The cylinder section is located particularly advantageously axially on a side of the disc unit facing away from the planetary gear stage, such that the rotor the planetary gear stage, the disc unit and the cylinder section therefore follow each other in the axial direction in the mentioned order.

A further very advantageous embodiment can also provide that the connecting element has a guide section designed to interact with the axial guide ring. Such a guide section of the connecting element can be used in order to axially guide the ring gear via the axial guide ring in the above-described sense.

The guide section is preferably arranged radially inside the cylinder section and axially overlapping the cylinder section. The guide section is connected to the disc unit for conjoint rotation and to the cylinder section for conjoint rotation.

In the preferable embodiment in which the axial guide ring is arranged radially inside and axially overlapping the freewheel clutch, the guide section of the disc unit is therefore provided in this region, preferably as a guide section having two sides, plane-parallel in the axial direction, which accordingly interact in a radially outwardly open guide ring equipped with plane-parallel flanges and having a u-shaped cross-section contour.

A very favorable embodiment of the electric drive device having a cylinder section of such type can also provide that this is arranged radially in a region of planetary gear bolts, supporting the planetary carrier, of the transmission stage in relation to the rotational axis. The cylinder section is therefore located radially at the same height as the planetary gear bolts of the planetary carrier, on which the planetary gears are arranged accordingly. This ensures a compact construction in which the cylinder section is designed nested radially inside the switchable freewheel clutch and in which, particularly preferably, the axial guide ring and a corresponding guide section of the disc unit are again arranged axially inside this cylinder section and axially overlapping this. As a result, a very compact construction is possible.

The switchable freewheel clutch advantageously has a first freewheel device designed to connect the ring gear to the housing for conjoint rotation when the rotor is operated in a forward-pull operation, and which is designed to decouple the ring gear from the housing when the rotor is operated in a forward-thrust operation.

Advantageously, the switchable freewheel clutch has a second freewheel device designed to connect the ring gear to the housing for conjoint rotation when the rotor is operated in a forward thrust operation or a reverse-pull operation. By means of the second freewheel device, in a forward operation of the associated motor vehicle, a recuperative operation of the electric engine can be realized and in a reverse operation of the motor vehicle, a propulsive operation of the electric engine can be realized.

Advantageously, the switchable freewheel clutch has a switching device designed to deactivate and activate the first freewheel device and/or the second freewheel device. With a deactivated freewheel device, the respective freewheel device cannot produce a connection between the ring gear and housing for conjoint rotation.

Very particularly advantageously, the switchable freewheel clutch has the first freewheel device and the second freewheel device and the switching device, wherein the switching device is specially designed to activate and deactivate the second freewheel device. In this embodiment, a forward-thrust operation can take place via the first freewheel device. Furthermore, if desired, a recuperative operation of the electric engine can take place in the forward operation of the motor vehicle via the second freewheel device, specifically when the second freewheel device is activated by means of the switching device. Similarly, with a second freewheel device, activated by means of the switching device, a reverse-pull operation of the motor vehicle can be realized. In contrast, with a second freewheel device, deactivated by means of the switching device, the ring gear can be separated from the housing in a forward-thrust operation of the motor vehicle, so that a sailing mode of the motor vehicle in the forward direction can be realized, for example, with a stationary rotor.

The actuator is advantageously designed to actuate the switching device. The actuator is, for example, a hydraulic actuator, such as a hydraulic cylinder, or an electromechanical actuator, such as a servomotor.

According to a particularly favorable embodiment of the electric drive device according to the invention, for a motor vehicle, the switchable freewheel clutch can have a switching disc, wherein the actuator is designed to move this rotationally. The switching disc is then a part of the switching device. The switchable freewheel clutch can in particular be designed in the manner described in the prior art of DE 10 2019 114 139 B3 cited in the introduction.

The construction of the switching disc can preferably be designed so that only one of the directions can be switched, specifically the reverse-pull direction, synonymous with the thrust-forward direction. Thus, reverse driving and forward recuperation is then possible. Switchability for the pull-forward direction, synonymous with the reverse-push direction is not necessarily required. Therefore, the wheel can be separated from the driven gear when reversing at a high speed, i.e., a reverse-thrust operation, however this is not necessary in practice, meaning that the construction can be simplified accordingly.

A further very advantageous embodiment of the electric drive device can also provide that the actuator of the switchable freewheel clutch is arranged in the housing or on the housing. Such an actuator arranged in or on the housing is easy to access in case maintenance or similar is necessary. According to a very advantageous development, the actuator can, in particular, be arranged radially outside the coupling halves and axially overlapping at least one of the coupling halves. This means that again installation space is saved in the axial direction and simple, easy-to-maintain actuation, if required, of the switching disc is enabled by the radially outer-lying actuator.

Further advantageous embodiments of the electric drive device according to the invention result from the exemplary embodiment which is represented in more detail below with reference to the figure.

### BRIEF DESCRIPTION OF THE SOLE DRAWING FIGURE

The sole drawing FIGURE attached shows a schematic sectional view through a part of an electric drive device that is relevant to the invention.

### DETAILED DESCRIPTION

In the illustration of the sole drawing FIGURE, an electric drive device 1 is represented in a section. The section is illustrated above the rotational axis A, which also defines the axial direction a and the radial direction r, accordingly. A rotor 3 of an electric engine 2 rotates around this rotational axis A. The electric engine 2 is designed as an axial flow machine in the exemplary embodiment shown here. The rotor 3, of which only the half on the right in the electric engine 2 or on the right of a stator 30 is illustrated here, is mounted via a roller bearing 6 with respect to a housing 5. It is connected to a rotor shaft 4 for conjoint rotation, which is designed in several parts. The rotor shaft is indirectly mounted via the roller bearing 6, designed as an angular contact ball bearing, of the rotor 3 and is also supported via a needle bearing 28 on the housing.

A driven gear 7 for a wheel of the motor vehicle is illustrated on the side of the electric engine 2 facing away in the axial direction a. This driven gear 7 is connected to a planetary gear carrier 8 for conjoint rotation, as a driven element of a planetary gear stage 13, via the output shaft 18 by means of a splined shaft toothing, labelled with 19.

In the particularly advantageous embodiment shown here, the electric drive device 1 is designed in such a way that the electric engine 2 thus drives only one single wheel of the motor vehicle. A complete electrically driven axle of the motor vehicle thus advantageously contains two electric drive devices 1 according to the invention.

The planetary carrier 8 has planetary gear bolts 9 protruding in the axial direction in the direction of the electric engine 2. Planetary gears 10, one of which can be seen here, are mounted on these planetary gear bolts 9 via a planetary gear bearing device 33, which here is designed in the form of two angular contact ball bearings 33.1 and 33.2. A sun gear 11 meshes radially inwardly with the planetary gears 10, which sun gear is advantageously formed here by a toothing of the rotor shaft 4. In addition to the sun gear 11 and the planetary carrier 10, the planetary gear stage 13 has a ring gear 12. The planetary gear stage 13 is designed for converting the torque between the rotor 3 and the driven gear 7.

The ring gear 12 does not have a separate direct roller bearing mounting with respect to the housing or with respect to other components and is supported instead indirectly on the housing 5 via the angular contact ball bearings 33.1 and 33.2 of the planetary gears 10 and via bearings 14.1 and 14.2 of the planetary gear carrier 8. The planetary gear carrier 8 is directly mounted against the housing by means of the bearings 14.1 and 14.2.

In order to ensure that the ring gear 12 cannot perform any significant movements in the axial direction a, an axial guide ring 15 is provided on the housing 5 in the exemplary embodiment shown here, which axial guide ring has a u-shaped contour in the cross-section, so that two flanges protrude radially outwards and the u-shaped contour is open radially outwards. The axial guide ring 15 is connected to the housing 5 axially fixed and for conjoint rotation and is arranged coaxially to the rotational axis A. A guide section 16, which is designed as an annular disc-shaped extension of a connecting element 24, protrudes into the u-shaped contour of the axial guide ring 15, which does not represent a roller bearing mounting but only a support for the guide, as a high-quality axial mounting is not necessary in this case. The connecting element 24 is connected to the ring gear 12 for conjoint rotation and accordingly rotates at the same angular velocity as the ring gear 12.

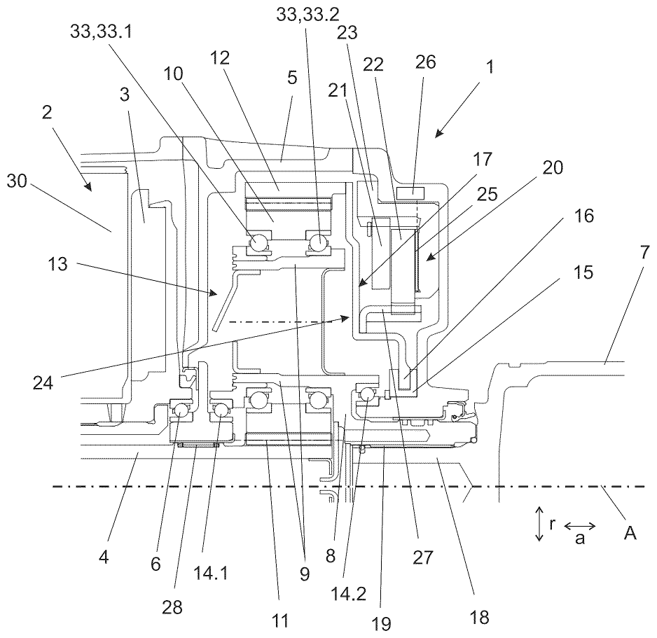

In the illustration of FIG. 1, the electric drive device 1 also comprises a switchable freewheel clutch 20 with a first coupling half 21 and a second coupling half 22. The first coupling half 21 is designed as a ring and is connected to the housing 5 via a freewheel carrier 23 for conjoint rotation. The second coupling half 22 is designed as a ring disc with internal toothing, which sits on a connecting element 24 and is connected to this by the toothing for conjoint rotation. The connecting element 24 has a cylinder section 27 connected to the disc unit 17 for conjoint rotation, whereby the second coupling half 22 is indirectly connected to the ring gear 12 via the connecting element 24 and the disc unit 17 for conjoint rotation. The switchable freewheel clutch 20 therefore acts on the ring gear 12, so that this either blocks or releases a connection between the ring gear 12 and the housing 5 in push or pull operation, depending on the switching position of a switching disc used as a switching device 25. The switching device 25 can be actuated via an actuator 26, wherein this actuator 26, which is in operative connection with the switching device 25 via the connection indicated by dashed lines, is located radially outside the switchable freewheel clutch 20 in the housing 5.

The switchable freewheel clutch 20 is therefore arranged at the position shown between the ring gear 12 and the housing 5 for design reasons, so that the first coupling half 21 is connected to the housing 5 for conjoint rotation. When the second coupling half 22 is decoupled from the first coupling half 21 and thus from the housing 5, the switching disc 25 holds down the corresponding pawls analogous to the construction of DE 10 2019 114 139 B3. This is the case in the forward-thrust operation when the forward-thrust side is deactivated. In this case, a non-switchable freewheel function can be arranged in the freewheel 16, in particular between the two coupling halves 21, 22. The switching disc 25 then lies between the second coupling half 22 and the housing 5 or the housing-fixed freewheel carrier 23, said switching disc, depending on the switching position, releasing or holding down spring-loaded pawls, which act in the opposite rotational direction of the freewheel function between the coupling halves 21, 22. This results in two switching states. A freewheel state and a completely coupled braking state, in which both directions are blocked.

This construction in which a separate bearing for the ring gear 12 is not available, but only an axial guide is provided via the axial guide ring 15, enables a very compact construction both in the axial as well as in the radial direction of the electric drive device 1 due to the nesting of the elements, which is possible in particular due to the disc unit 17, the cylinder section as a connecting element 24 and the guide section 16.

In the advantageous construction of the embodiment of the sole FIGURE, the disc unit 17 of the connecting element 24 is arranged on a side of the planetary gear stage 13 facing away from the electric engine 2 with regard to the axial direction a. Furthermore, the cylinder section 27 is arranged on a side of the disc unit 17 facing away from the planetary gear stage 13 with regard to the axial direction. The guide section 16 is arranged axially overlapping and radially inside the cylinder section 27, wherein the u-shaped contour of the axial guide ring 15 is radially open to the outside, so that the guide section 16 engages radially inwardly in the axial guide ring 15.

The axial guide ring 15 is advantageously arranged in a radially inner edge region of the planetary gear bolts 9, in relation to the rotational axis A, so that a circle indicated by the axial guide ring 15 is radially inside a circle which is arranged coaxially to the rotational axis A and the circumference of which is intersected by the rotational axes of the planetary gears 10.

The switchable freewheel clutch 20 is arranged axially overlapping the cylinder section 27 and also axially overlapping the axial guide ring 15, wherein the switchable freewheel clutch 20 is arranged radially outside the cylinder section 27.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 electric drive device
2 electric engine
3 rotor
4 rotor shaft
5 housing
6 bearing (of the rotor)
7 driven gear
8 planetary carrier
9 planetary gear bolts
10 planetary gears
11 sun gear
12 ring gear
13 planetary gear stage
14.1, 14.2 bearing
15 axial guide ring
16 guide section
17 disc unit
18 output shaft
19 splined shaft toothing
20 switchable freewheel clutch
21 first coupling half
22 second coupling half
23 freewheel carrier
24 connecting element
25 switching disc
26 actuator
27 cylinder section (of 24)
28 needle bearing
30 stator
A rotational axis
a axial direction
R radial direction

1-11. (canceled)

12. An electric drive device for a motor vehicle, the electric drive device comprising:
an electric engine having a rotor;
a planetary gear stage having a sun gear, a planetary carrier with planetary gears, and a ring gear;
a switchable freewheel clutch having a first coupling half, a second coupling half, a switching device, and an actuator, wherein the first coupling half is connected to a housing to conjointly rotate; and
an axial guide ring configured to support the ring gear in both axial directions, wherein the ring gear does not have a roller bearing directly supports it, wherein the axial guide ring is arranged radially inside and axially overlapping the freewheel clutch, wherein the axial guide ring has a u-shaped cross-section contour.

13. The electric drive device of claim 12, wherein the second coupling half is connected to the ring gear to conjointly rotate, wherein a connecting element, which is connected to the ring gear to conjointly rotate and to the second coupling half to conjointly rotate, is arranged radially between a sun gear toothing of the sun gear and a ring gear toothing of the ring gear in relation to a rotational axis of the planetary gear stage.

14. The electric drive device of claim 13, wherein the connecting element has a cylinder section arranged coaxially to the rotational axis of the planetary gear stage.

15. The electric drive device of claim 14, further comprising:
a disc unit configured to connect the cylinder section to the ring gear to conjointly rotate.

16. The electric drive device of claim 15, wherein the rotor is arranged coaxially to the planetary gear stage and the disc unit is arranged axially on a side of the planetary gear stage facing away from the rotor, wherein the cylinder section is arranged axially on a side of the disc unit facing away from the planetary gear stage.

17. The electric drive device of claim 15, wherein the connecting element has a guide section configured to interact with the axial guide ring.

18. The electric drive device of claim 14, wherein the cylinder section is arranged radially in a region of planetary gear bolts, which support the planetary gears, of the planetary carrier of the planetary gear stage in relation to the rotational axis of the planetary gear stage.

19. The electric drive device of claim 12, wherein the switching device is a switching disk, and wherein the actuator is configured to move the switching disk rotationally.

20. The electric drive device of claim 12, wherein the actuator of the switchable freewheel clutch is arranged in the housing.

21. The electric drive device of claim 12, wherein the actuator of the switchable freewheel clutch is arranged radially outside the first and second coupling halves or axially overlapping at least one of the first and second coupling halves.
